(19) United States
(12) Patent Application Publication
(10) Pub. No.: US 2017/0270250 A1
(43) Pub. Date: Sep. 21, 2017

(54) BUILDING A PATIENT'S MEDICAL HISTORY FROM DISPARATE INFORMATION SOURCES

(71) Applicant: International Business Machines Corporation, Armonk, NY (US)

(72) Inventors: Elizabeth T. Dettman, Rochester, MN (US); Andrew R. Freed, Cary, NC (US); Michael W. Schroeder, Rochester, MN (US); Fernando J. Suarez Saiz, Armonk, NY (US)

(21) Appl. No.: 15/076,450

(22) Filed: Mar. 21, 2016

(51) Int. Cl. G06F 19/00

(52) U.S. Cl. CPC G06F 19/322; G06F 19/345

(57) ABSTRACT

A patient's medical history is built by applying natural language processing to multiple patient records and identifying medical concepts with associated dates for each document. The documents are grouped into clusters based on the dates, and a primary concept is determined for each cluster by performing an analysis which assigns confidence values to the documents and selects the medical concept in the document having the highest confidence value as the primary concept. Primary concepts from respective document clusters are combined to generate a combined history. If the combined history is not feasible due to a conflict between primary concepts, the documents can be re-grouped into different clusters, and the analysis repeated. The invention can further identify an inter-concept conflict among the primary concepts involving at least two different concept types, then receive guidelines pertaining to relationships between the different concept types, and resolve the conflict by applying the relationships.

### BACKGROUND OF THE INVENTION

Field of the Invention

The present invention generally relates to health care diagnosis and treatment, and more particularly to a method of evaluating information to determine the relevant medical history of a patient.

Description of the Related Art

Over the years medicine has become an increasingly complex science. In other to properly treat a patient, it is accordingly important to understand as much as possible about the patient's medical history. Much of this information can be gleaned from electronic documents, but there is also often a trail of paper (hard copy) records that should be examined. These can include a multitude of notes, forms and publications from different authors over a wide range of time.

While experienced doctors are still the best at determining a proper diagnosis and crafting appropriate therapies and responses, computer-based intelligent advisors such as Watson Oncology Advisor and Watson Oncology Expert Advisor have been developed to assist with these functions. Physicians, oncologists, and these intelligent advisors need an accurate representation of a patient's history in order to understand a patient's current state and to develop treatment plans for the future with the highest likelihood of success.

### SUMMARY OF THE INVENTION

The present invention in at least one embodiment is generally directed to building a patient's medical history by receiving electronic documents pertaining to the patient's past health care, applying natural language processing to identify at least one medical concept and a date associated with the medical concept for each document, grouping the electronic documents based on the associated dates into document clusters, determining a primary concept for each document cluster including performing an analysis which assigns confidence values to each of the documents in a given cluster and selects the concept in the document having the highest confidence value as the primary concept, and combining primary concepts from respective document clusters to generate a combined history. If the combined history is not feasible due to a conflict between primary concepts from different clusters, the electronic documents can be re-grouped into different document clusters, and the analysis repeated for the different document clusters. The grouping can be performed in such a way as to make at least one of the clusters have at least two medical concepts which are the same. The analysis may include determining that a particular cluster has a minimum predefined number of documents, with the primary concept for the particular cluster appearing in a majority of the documents in the particular cluster. The analysis may also include removing one or more documents from a particular cluster. In an illustrative implementation, the medical concepts include a therapy concept type, a treatment concept type, and a diagnosis concept type. The invention can further identify an inter-concept conflict among the primary concepts involving at least two of the concept types that are different, then receive guidelines pertaining to relationships between the different concept types, and resolve the conflict by applying the relationships to select a different primary concept for at least one of the document clusters and thereby generate a different combined history.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a block diagram of a computer system programmed to carry out evaluation of a patient's medical history in accordance with one implementation of the present invention;

FIG. 2 is a pictorial representation of a plurality of documents pertaining to a patient's medical history being ingested via natural language processing to provide medical concepts relating to the patient with dates or date ranges in accordance with one implementation of the present invention;

FIG. 3 is a timeline showing how multiple medical history documents can be clustered and a primary concept from each cluster selected to produce a probable concept history in accordance with one implementation of the present invention;

FIG. 4 is a timeline showing an example of clusters of medical history documents pertaining to therapies being correlated with clusters of medical history documents pertaining to diagnoses in accordance with one implementation of the present invention;

FIG. 5 is a pictorial representation of a medical guidelines document providing known relationships between medical concepts such as therapies and diagnoses in accordance with one implementation of the present invention;

FIG. 6 is a chart illustrating the logical flow for intra-concept correlation in accordance with one implementation of the present invention; and

FIG. 7 is a chart illustrating the logical flow for correlation of different history elements in accordance with one implementation of the present invention.

The use of the same reference symbols in different drawings indicates similar or identical items.

### DESCRIPTION OF THE PREFERRED EMBODIMENT(S)

In health care, to properly treat a patient it is important to understand their entire medical history, including their current/past ailments, current/past treatments, and responses to these treatments. This history is difficult to piece together, as it is generally recorded across various documents written years apart by different authors with different perspectives, goals, and terminology.

Generally a patient case file has a list of documents which contain many different concept types (e.g., therapies received, diagnoses, responses, etc.). Over time, a patient's care may generate a numerous amount of clinical notes, which may have complex interdependencies, duplications of information, or omissions of information. For example, one doctor's “protocol A” may be the same treatment as a different doctor's “Treatment X,” and both may include drugs B, C, and D. As such, the patient's clinical notes may be more confusing than helpful to a caregiver, especially a caregiver that is new to providing care to this patient. The documents are generally not evenly distributed over time, but for concept mining there are patterns that can be exploited in these time-patterns.

One approach to this concept mining is set forth in U.S. patent application Ser. No. 14/514,563 filed Oct. 15, 2014,which is hereby incorporated. In that system, a therapy history timeline is built using documents with drug start dates, combined with correlations from guidelines to determine drug regimens and cycles. However, error detection is only achieved by eliminating drug references that directly conflict with an implied regimen, and this approach lacks a robust conflict resolution mechanism. Furthermore, this approach only considers one concept at a time (e.g., just therapy history).

It would, therefore, be desirable to devise an improved method of building a patient's medical history from disparate information sources. It would be further advantageous if the method could more reliably detect and resolve history conflicts. The present invention achieves these goals by correlating additional information sources (to improve accuracy) and by considering additional methods for rejecting false history entries. This process is preferably carried out in two parts or processes. In the first process, concepts can be ingested from documents using natural language processing NLP), with a frequency/weighting mechanism to filter out low-quality concepts (scoring) like one-time mentions and documents that give conflicting information. A series of time-boxed windows can be used to determine the most probable concepts within that window, with the scoring to filter out less-likely concept instances. The window sizes can vary, for example based on frequency of documents and expected size of window (e.g., for a treatment regimen, a window might be 6-12 months, which is the average length of a regimen). In the second process, concepts can be correlated into a history, including inter-concept relations (not just intra-concept relations). For example, 10-12 drugs are used in 90% of lung cancer cases—thus therapy history can be used to infer diagnosis history, or vice-versa. A series of relationships and inferences can then be invoked to determine how to best combine several different intra-concept histories into a single inter-concept history by scoring each concept history not just on how coherent it is by itself, but how well it fits with other concepts.

These two parts of the preferred implementation can be run serially, first as intra-concept correlation and then as inter-concept correlation. However, they can also be run in parallel, just meaning that more potential inter-concept histories are built.

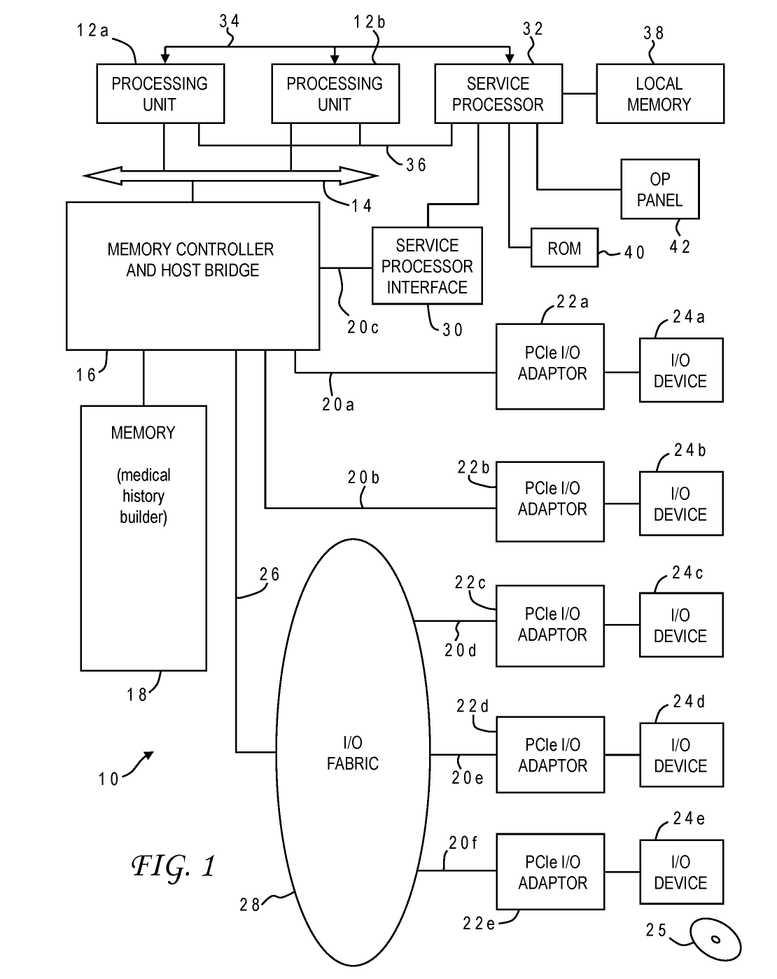

With reference now to the figures, and in particular with reference to FIG. 1, there is depicted one embodiment 10 of a computer system in which the present invention may be implemented to carry out the construction of a patient's medical condition from a variety of historical documents. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches. System memory 18 has loaded therein a medical history builder application in accordance with the following disclosure.

MC/HB 16 has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f. These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the medical history builder application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for a medical history build process that uses novel correlation techniques to provide an improved patient profile. Accordingly, a program embodying the invention may include conventional aspects of various medical history tools, and these details will become apparent to those skilled in the art upon reference to this disclosure.

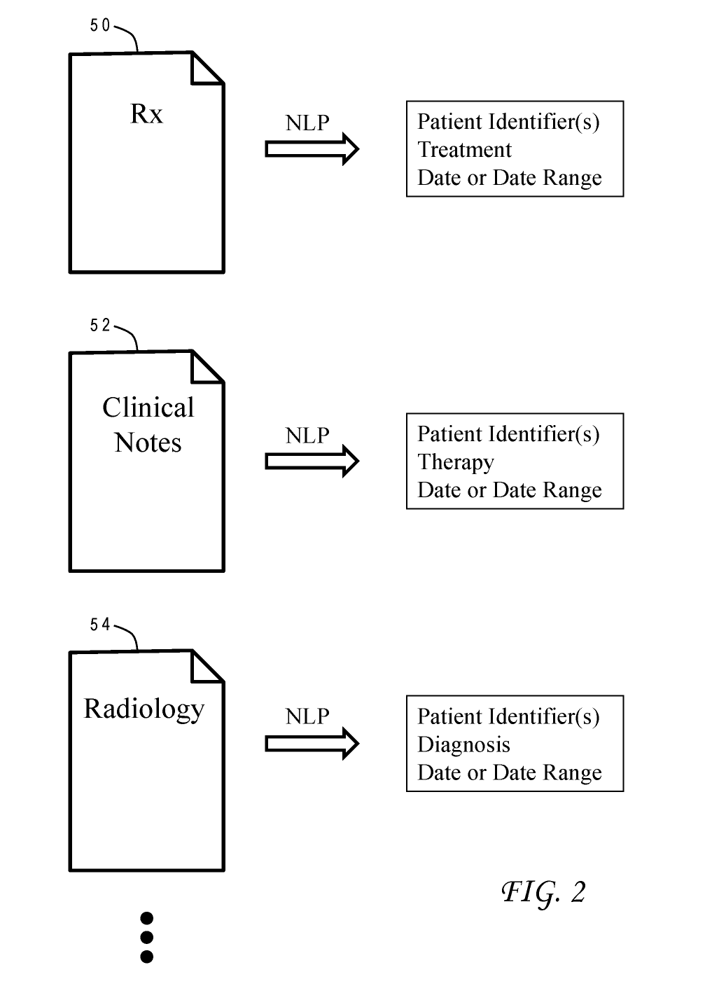

Referring now to FIG. 2, there is depicted a plurality of documents from various information sources pertaining to a patient's medical history which are to be ingested by computer system 10. The sources may include, for example, doctors, nurses, in-house assistants, lab results providers, a computer which generates notes, etc. As such, the format and information included in the documents varies based upon the preferences of the different sources. For example, a first note might state that a patient was on “protocol A”, a second note might state that a patient was on “drug B”, a third note may state that “the patient was on Treatment X starting July 2014”. While the documents may be scanned copies of paper records subjected to optical character recognition, they may also include electronic medical records pertaining to a patient, such as clinical notes, radiology reports, transcribed documents, prescriptions, etc. These examples of documents are not to be construed in a limiting sense as they may generally be any document pertaining to medical history.

The documents can be ingested by computer system 10 using natural language processing (NLP). NLP is a known science which enables computers to derive meaning from human or natural language input. In some NLP methodologies, a text annotator program searches text in documents and analyze it relative to a defined set of tags. The front-end NLP can include identification of a lexical answer type and a focus, and creation of a common analysis structure. Lexical answer type, focus and common analysis structure are known features of the prior art. Those skilled in the art will appreciate that the present invention may be applied to other analysis techniques which can parse a natural language document which includes medical terminology.

In accordance with one implementation of the present invention, FIG. 2 shows three documents being ingested via NLP to provide medical concepts relating to the patient, with dates or date ranges (as used herein, “date” includes both specific dates and date ranges). In the example of FIG. 2, the documents include a prescription 50, clinical notes 52, and a radiology report 54. Each of these documents can have a patient identifier. The patient identifier can be a name, social security number, or any other indicia which can be associated with the patient in a known manner, such as a patient number used at a clinic. The documents do not necessarily contain the patient identifier but if not, they have been included as part of the ingestion procedure due to some other reason for inclusion, e.g., manual identification as being associated with the patient. Each document also has a date or date range. Each document further contains some medical concept. In this example, prescription 50 references a drug used in as part of a treatment regimen, clinical notes 52 indicate a therapy which may be, e.g., a physical therapy or chemotherapy, and radiology report 54 includes a likely diagnosis for a patient condition. There may be more than one medical concept in the document, including different types. For example, there may be two treatments indicated in a single document, or a diagnosis and related therapy in a single document. The collection of this related medical information for a particular document constitutes a history element. So if the patient's treatment history was AB in 2000, with a therapy C in 2001, and a diagnosis D in 2002, then each of those three are the history elements.

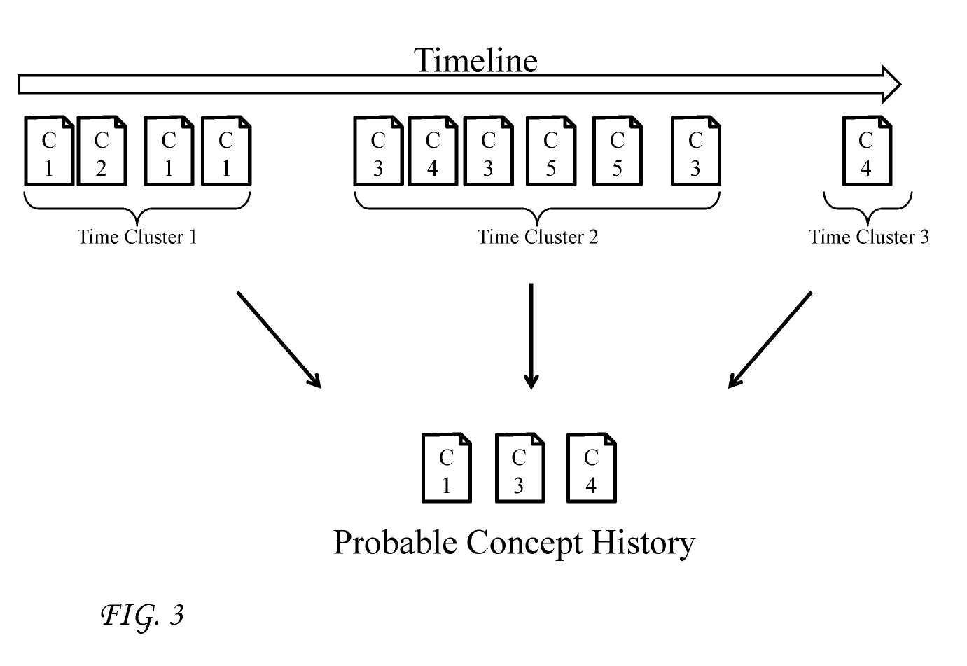

FIG. 3 shows how these history elements can be clustered by time (chronologically) to improve intra-concept correlation in accordance with one exemplary application of the present invention. Computer system 10 has ingested multiple documents and arranged (ordered) them along a timeline according to the date or date range of each document. In this example, there are eleven documents which have been organized into three time clusters. Some documents reference the same medical concept. In the first (oldest) cluster there are four documents, three of which pertain to a first concept C1 and one of which pertains to a second concept C2. In the second time cluster there are six documents, three of which pertain to a third concept C3, one of which pertains to a fourth concept C4, and two of which pertain to a fifth concept C5. There is only one document in the last (most recent) cluster, pertaining to the fourth concept C4.

Clustering of the documents can be performed by computer system 10 based on a variety of factors. For example, for building a therapy history date range, computer system can use the length of an average treatment (say, 6-12 months). Other time windows are possible, both longer and shorter. A domain expert could manually set the ideal cluster date range as an input to computer system 10, or a range can be inferred from supporting data about the concepts themselves. Sliding time windows are also possible, so a single document (history element) may be included in two different time clusters. Ideally, a cluster is formed so that at least one concept appears twice in that cluster (in the treatment example, two instances of the same therapy), so computer system 10 may adjust the cluster date range within predefined constraints to accommodate this goal. For example, computer system 10 may use a default cluster range of 6-12 months but if no concept appears twice in a cluster with this basis then the range might be adjusted to 3-15 months. If a document has a date range but no specific date, any reasonable date can be used such as the midpoint of the date range, but if the range is too wide (beyond some predetermined range like two years) then it can be omitted entirely.

Once the documents have been clustered, computer system 10 can perform an analysis to determine the most likely concept within a date group. Dominant concepts from each cluster can then be selected to produce a probable concept history, as seen in FIG. 3. Further to that example, concept C1 has been selected for time cluster 1, concept C3 has been selected for time cluster 2, and concept C4 has been selected for time cluster 3. These three concepts together form the probable concept history, in date order based on the cluster order.

The analysis used to determine the most appropriate concept in a cluster can again be performed by computer system 10 based on a variety of factors. For example, for a reasonably large cluster (i.e., having some minimum predefined number of documents N), if a concept appears in the majority of the documents that is the most probable concept for that cluster. If a clear favorite is not found according to such base criteria, the cluster can be culled, such as by removing concepts appearing only once in a cluster, or removing documents that support multiple candidate clusters. Computer system 10 can assign a confidence value for the favored concept within a cluster; for example, the confidence value could be the number of documents supporting the concept in the cluster divided by the number of total documents in the cluster. The best answers from the clusters are then combined into the probable concept history.

In some embodiments, this probable concept history is just a candidate or proposed history, and can be rejected. Computer system 10 can perform a further analysis to determine if a particular combined history is feasible. For example, with a therapy history, if regimens represented by the primary concepts are not spaced far enough apart in time according to relevant guidelines, then the proposed history can be rejected. For a diagnosis history, it would be possible that a diagnosis could progress from myelodysplastic syndromes (MDS) to acute myeloid leukemia (AML), but the diagnosis would never progress from AML to MDS. Another false diagnosis history could show a primary cancer first as lung cancer, one month later as breast cancer, and two weeks later as lung cancer, as the primary diagnosis would never change that fast.

If a candidate history is found to be unfeasible, the analysis can be repeated with a different set of clusters. For example, small clusters (i.e., one document, or below some predefined threshold) can be culled from the timeline, although exceptions to this rule can be made such as when the cluster is the most recent. Also, for history elements that generate the invalid history, their date cluster can be expanded or contracted. The process can be repeated until the best combined history is generated. Multiple candidate histories can be considered feasible; in such a case the one with the highest combined confidence values can be selected, or other criteria can be used to pick the best concept history.

The history building process can be understood with regard to two further examples. According to the first example, computer system 10 is trying to decide whether a patient's treatment history includes all of AB, CD, EF, GH, or some combination thereof, based on eight documents in the patient history. Document 1 indicates that the patient was treated with drug A in June of 2000. Document 2 states that the patient continued regimen AB with drug B in July of 2000. Document 3 suggests that a previous treatment was unsuccessful, and as of April 2002 (in the future) a new drug C will be administered. Document 4 asserts that if this treatment does not work, a new regimen EF will be given to the patient in June of 2002. Document 5 indicates that a doctor continued treatment by giving drug D in June of 2002. Document 6 notes that, in June of 2002, the patient complained that regimen CD is an even worse than regimen AB, and asked about switching to regimen EF. Document 7 shows that the patient started regimen GH in January of 2004. Finally, Document 8 indicates that the patient completed regimen GH in July of 2004 and achieved complete remission of symptoms. From these documents, computer system 10 can detect five possible regimens received: AB, CD, EF, AB (again), and GH. From guidelines provided to computer system (see U.S. patent application Ser. No. 14/514,563), it is known that only one of AB/CD/EF was actually given in 2002 since they conflict, even though there is evidence for all three. While these guidelines maintain that only one of the three treatments is possible, the prior art does not have any mechanism for picking the correct one. Systems such as that disclosed in U.S. patent application Ser. No. 14/514,563 are forced to simply make a random selection among AB/CD/EF. The present invention uses additional analysis to select the most appropriate history element. Computer system 10 will rank Document 6 as low quality since it is not recent (over two years old, with 25% of the documents newer than this), and regimen AB is a one-time mention within the cluster. Regimen EF is mentioned twice, however one mention is in the low-quality Document 6. Regimen CD is mentioned three times (including the low-quality Document 6). From this scoring, the patient received CD in 2002, not AB or EF. The complete concept history is therefore AB in 2000, CD in 2002, and GH in 2004.

According to the second example, the same patient has the same eight documents with a new Document 9 which indicates that the patient relapsed in late 2004 and immediately started on regimen IJ Even though IJ is a one-time mention, it is the most recent document and it should therefore be probable that IJ is part of the therapy history (noting also, it does not conflict with guidelines)

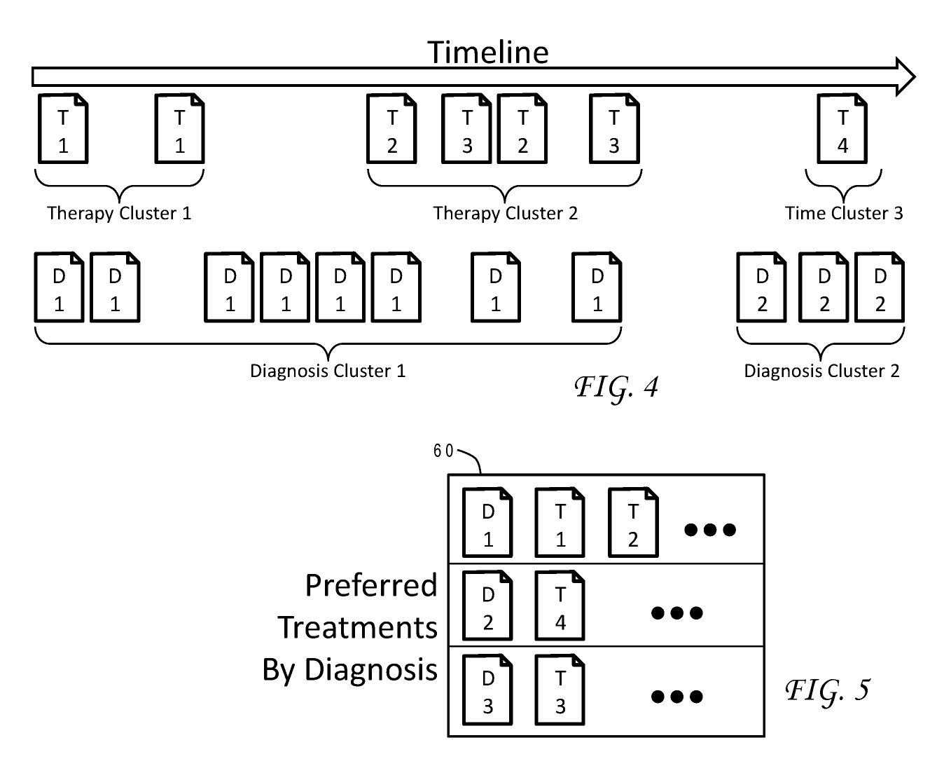

In the foregoing examples, a probable concept history is still not as complete of a solution as desired. Intra-concept history can generate several conflicting histories, especially if there are sparse numbers of documents supporting multiple hypotheses. Further analysis can be used to combine different concept histories into a coherent whole. FIG. 4 illustrates one application of the present invention using clusters of medical history documents pertaining to therapies which are to be correlated with clusters of medical history documents pertaining to diagnoses. Those skilled in the art understand that this is only one example and similar analyses can be applied to other medical concepts besides therapies and diagnoses, and can correlate more than just two types of medical concept clustering. In FIG. 4, the therapy documents have been arranged into three clusters. The first therapy cluster has two documents, both pertaining to a first therapy T1. The second therapy cluster has four documents, two pertaining to a second therapy T2 and two pertaining to a third therapy T3. The third therapy cluster has only one document pertaining to a fourth therapy T4. The diagnosis documents have been arranged into two clusters. The first diagnosis cluster has eight documents, all pertaining to a first diagnosis D1. The second diagnosis cluster has three documents, all pertaining to a second diagnosis D2. The first diagnosis cluster generally overlaps chronologically with the first two therapy clusters, and the second diagnosis cluster generally overlaps with the third therapy cluster.

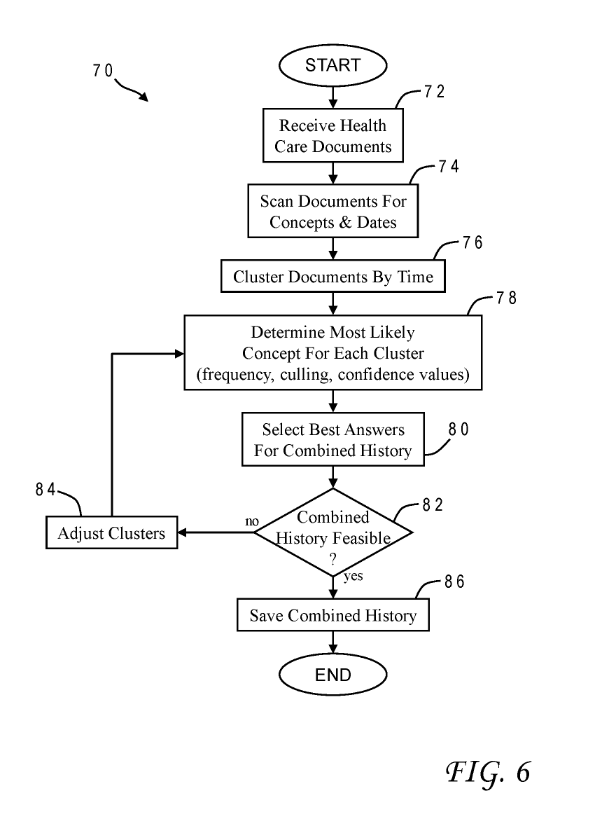

In order to better correlate the therapies with the diagnoses, computer system 10 can ingest a set of guidelines 60 seen in FIG. 5. The nature of the guidelines can vary significantly based on the specific medical concepts involved, but generally they provide some basis for inter-concept relationships. For example the guidelines can indicate different treatments that are likely used for different cancer diagnoses. In FIG. 5 the guidelines set forth at least three likely relationships: diagnosis D1 is associated with therapies T1 and T2, diagnosis D2 is associated with therapy T4, and diagnosis D3 is associated with therapy T3. The guidelines may contain other relationships, not shown but indicated by the ellipses. In FIG. 4 it can be seen that therapy cluster 2 is ambiguous, as either the T2 or T3 therapy is possible; for this example the T2 and T3 documents are given equal weight, i.e., there is no intra-concept basis to assign a lower confidence value to either therapy. However, by correlating to relationships from guidelines 60, it is observed that the T2 therapy is much more frequently administered to other patients with the same diagnosis as the subject patient (diagnosis D1). It can thus be concluded that the T2 therapy is more likely part of the patient's medical history. Accordingly, computer system 10 can result in a final combined patient history solution of therapy T1 with diagnosis D1 early in the timeline, therapy T2 with diagnosis D1 in the middle of the timeline, and therapy T4 with diagnosis D2 late in the timeline.

The inter-concept guidelines can include a vary of relational bases to resolve low-confidence individual concept histories. A relationship may indicate how often one concept leads to a different concept (e.g., 90% of the mentions of a given therapy are related to a particular diagnosis). A relationship may indicate how often one concept progression influences a different concept progression (e.g., a history of regimen AB followed by CD and then EF typically happens when the disease metastasizes, and a secondary diagnosis is likely around the beginning of regimen EF). A relationship may indicate how one concept occurring means another concept should never occur (e.g., when a “failed treatment response” is found on Date X, a different regimen should be seen before and after Date X). The same therapy appearing some time span (say, at least 6 months) after the first occurrence of the therapy can indicate a recurrence of the disease.

In a further example, lung cancer guidelines indicate 10-12 drugs that are commonly used in 90% of cases. Referring back to the first text example above, it is presumed for this further example that regimen CD and regimen EF were similarly weighted for the 2002 history entry. From the guideline examination, computer system 10 finds that regimen CD correlates most strongly to lung cancer and regimen EF correlates most strongly to breast cancer. If the diagnosis history for the patient suggests lung cancer from 1999-2007 and then melanoma from 2010 onward, computer system 10 will conclude that regimen CD was most likely administered to this patient in 2002.

Additional cognition could be provided in the conflict resolution mechanism. For example, if the documents suggest an inconsistent timeline of therapies with diagnoses and there were two equally weighted choices, both yielding a similarly consistent final result, there are two approaches that could be implemented. First, it could be assumed that the diagnoses were correct in which case the interpretation of the therapies would be adjusted. Conversely, it could be assumed that the therapies were correct in which case the interpretation of the diagnoses would be adjusted. Machine-learning protocols could be used to identify over time which choice was the best based on the attributes of the patient case. It may be that most of the time when there are conflicts with lung cancer as the diagnosis, it is the therapies that are wrong, but for some rare cancer type (ex: ear cancer) it's the therapies that are usually right and the cancers usually wrong. Since there are so many possible combinations of therapy/diagnosis/response, a machine-learning implementation could help fine-tune the conflict resolution.

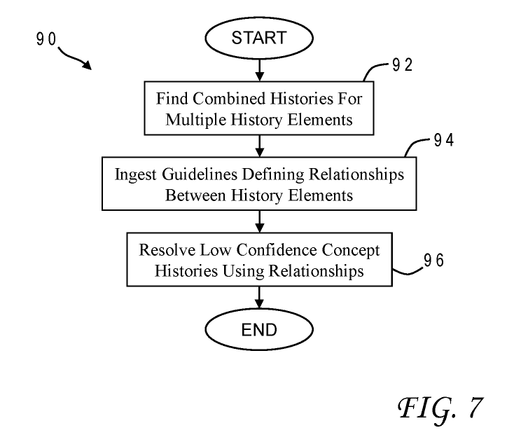

The invention may be further understood with reference to the charts of FIGS. 6 and 7 which illustrate the logical flow for an intra-concept correlation process and an inter-concept correlation process in accordance with one implementation of the present invention. The intra-concept correlation process 70 of FIG. 6 begins by receiving the health care documents pertaining to the subject patient (72). These documents are scanned or otherwise ingested to find medical concepts with associated dates (74). The documents are then clustered by time (76). For each cluster, the most likely concept is determined based on a variety of factors, which may include frequency, culling of certain documents, or assignment of different confidence values to the documents (78). The best answer from each cluster is selected to form a candidate combined history (80). Intra-concept guidelines are then used to determine whether the candidate combined history seems feasible (82). If not, the clusters are adjusted (84), and the process iteratively returns to box 78. Once a candidate combined history is found that is feasible, that combined history is saved as a solution (86).

The inter-concept correlation process 90 of FIG. 7 begins by finding combined histories for multiple history elements (92). Guidelines are ingested that define relationships between at least some of these history elements (94). Low confidence concept histories can then be resolved using the guideline relationships (96).

The present invention thereby allows a cognitive system to more accurately piece together a patient's medical history documents, and provides a robust resolution mechanism for intra-concept conflicts. Inter-concept correlations also increase the likelihood of developing a more coherent combined patient history.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the invention has been disclosed in conjunction with examples pertaining to cancer diagnoses and treatments, it is more generally applicable to any medical conditions, including mental health diagnoses. It is therefore contemplated that such modifications can be made without departing from the spirit or scope of the present invention as defined in the appended claims.

What is claimed is:

1. A method of building a patient's medical history comprising:
receiving a plurality of electronic documents pertaining to the patient's past health care, by executing first instructions in a computer system;
applying natural language processing to identify, for each electronic document, at least one medical concept and a date associated with the medical concept, by executing second instructions in the computer system;
grouping the electronic documents based on the associated dates into one or more document clusters, by executing third instructions in the computer system;
determining a primary concept for each document cluster, the primary concept being one of the medical concepts in at least one of the electronic documents in a given document cluster, by executing fourth instructions in the computer system, wherein said determining includes performing an analysis which assigns confidence values to each of the documents in the given document cluster and selects the medical concept in the document having the highest confidence value as the primary concept; and
combining primary concepts from respective document clusters to generate a combined history, by executing fifth instructions in the computer system.

2. The method of claim 1, further comprising:
determining that the combined history is not feasible due to a conflict between primary concepts from different document clusters, by executing sixth instructions in the computer system;
grouping the electronic documents into different document clusters; and
repeating said determining for the different document clusters.

3. The method of claim 1 wherein said grouping is performed in such a way as to make at least one of the document clusters have at least two of the medical concepts which are the same.

4. The method of claim 1 wherein the analysis further includes determining that a particular document cluster has a minimum predefined number of documents, and the primary concept for the particular document cluster appears in a majority of the documents in the particular document cluster.

5. The method of claim 1 wherein the analysis further includes removing one or more documents from a particular document cluster.

6. The method of claim 1 wherein the medical concepts include at least one of a therapy concept type, a treatment concept type, or a diagnosis concept type.

7. The method of claim 6 further comprising:
identifying an inter-concept conflict among the primary concepts, wherein the inter-concept conflict involves at least two of the concept types that are different;
receiving guidelines pertaining to relationships between the different concept types; and
resolving the conflict by applying the relationships to select a different primary concept for at least one of the document clusters and thereby generate a different combined history.

8. A computer system comprising:
one or more processors which process program instructions;
a memory device connected to said one or more processors; and
program instructions residing in said memory device for building a patient's medical history by receiving a plurality of electronic documents pertaining to the patient's past health care, applying natural language processing to identify, for each electronic document, at least one medical concept and a date associated with the medical concept, grouping the electronic documents based on the associated dates into one or more document clusters, determining a primary concept for each document cluster, the primary concept being one of the medical concepts in at least one of the electronic documents in a given document cluster, by performing an analysis which assigns confidence values to each of the documents in the given document cluster and selects the medical concept in the document having the highest confidence value as the primary concept, and combining primary concepts from respective document clusters to generate a combined history.

9. The computer system of claim 8 wherein said program instructions further determine that the combined history is not feasible due to a conflict between primary concepts from different document clusters, group the electronic documents into different document clusters, and repeat the analysis for the different document clusters.

10. The computer system of claim 8 wherein the grouping is performed in such a way as to make at least one of the document clusters have at least two of the medical concepts which are the same.

11. The computer system of claim 8 wherein the analysis further includes determining that a particular document cluster has a minimum predefined number of documents, and the primary concept for the particular document cluster appears in a majority of the documents in the particular document cluster.

12. The computer system of claim 8 wherein the analysis further includes removing one or more documents from a particular document cluster.

13. The computer system of claim 8 wherein the medical concepts include at least one of a therapy concept type, a treatment concept type, or a diagnosis concept type.

14. The computer system of claim 13 wherein said program instructions further identify an inter-concept conflict among the primary concepts, wherein the inter-concept conflict involves at least two of the concept types that are different, receive guidelines pertaining to relationships between the different concept types, and resolve the conflict by applying the relationships to select a different primary concept for at least one of the document clusters and thereby generate a different combined history.

15. A computer program product comprising:
a computer readable storage medium; and
program instructions residing in said storage medium for building a patient's medical history by receiving a plurality of electronic documents pertaining to the patient's past health care, applying natural language processing to identify, for each electronic document, at least one medical concept and a date associated with the medical concept, grouping the electronic documents based on the associated dates into one or more document clusters, determining a primary concept for each document cluster, the primary concept being one of the medical concepts in at least one of the electronic documents in a given document cluster, by performing an analysis which assigns confidence values to each of the documents in the given document cluster and selects the medical concept in the document having the highest confidence value as the primary concept, and combining primary concepts from respective document clusters to generate a combined history.

16. The computer program product of claim 15 wherein said program instructions further determine that the combined history is not feasible due to a conflict between primary concepts from different document clusters, group the electronic documents into different document clusters, and repeat the analysis for the different document clusters.

17. The computer program product of claim 15 wherein the grouping is performed in such a way as to make at least one of the document clusters have at least two of the medical concepts which are the same.

18. The computer program product of claim 15 wherein the analysis further includes determining that a particular document cluster has a minimum predefined number of documents, and the primary concept for the particular document cluster appears in a majority of the documents in the particular document cluster.

19. The computer program product of claim 15 wherein the analysis further includes removing one or more documents from a particular document cluster.

20. The computer program product of claim 15 wherein the medical concepts include at least one of a therapy concept type, a treatment concept type, or a diagnosis concept type.

21. The computer program product of claim 20 wherein said program instructions further identify an inter-concept conflict among the primary concepts, wherein the inter-concept conflict involves at least two of the concept types that are different, receive guidelines pertaining to relationships between the different concept types, and resolve the conflict by applying the relationships to select a different primary concept for at least one of the document clusters and thereby generate a different combined history.
